(19) United States
(12) Patent Application Publication
(10) Pub. No.: US 2012/0084940 A1
(43) Pub. Date: Apr. 12, 2012

(54) Castor Having a Greater Structural Strength to Bear a Heavier Load

(76) Inventor: Po-Chuan Tsai, Rende Hsiang (TW)

(21) Appl. No.: 12/899,640

(22) Filed: Oct. 7, 2010

(51) Int. Cl. B60B 33/00

(52) U.S. Cl. 16/37

(57) ABSTRACT

A castor includes a castor body, a first bushing mounted on a top of the castor body, a bearing mounted in the first bushing, a top cover mounted on the top of the castor body to cover the first bushing and the bearing, a second bushing mounted on a bottom of the castor body, and an upright shaft in turn extending through the top cover, the bearing, the castor body and the second bushing. Thus, the distance between the top cover and the second bushing is increased so that the bearing and the castor body can bear a heavier load. In addition, the distance between the top cover and the second bushing is increased so that the upright shaft and the second bushing can bear a greater rotational force.

### BACKGROUND OF THE INVENTION

1. Field of the Invention

The present invention relates to a castor and, more particularly, to a castor for an office chair.

2. Description of the Related Art

A conventional castor 1 in accordance with the prior art shown in FIG. 7 comprises a shaft 11 having a lower end integrally formed with a top cover 110, a castor body 10 mounted on the lower end of the shaft 11, a bottom cover 12 mounted on the lower end of the shaft 11, a first bearing 13 mounted on the shaft 11 and biased between the top cover 110 and the castor body 10, and a second bearing 14 mounted on the shaft 11 and biased between the castor body 10 and the bottom cover 12. However, the distance between the top cover 110 and the bottom cover 12 is short so that the shaft 11 and the castor body 10 cannot bear a heavier load. In addition, the distance between the top cover 110 and the bottom cover 12 is short so that lower end of the shaft 11 cannot bear a heavier rotational force, and the shaft 11 is easily loosened or vibrated during a long-term utilization. Further, the parts of the castor 1 are made of metal so that the castor 1 easily produces noise during rolling.

### BRIEF SUMMARY OF THE INVENTION

In accordance with the present invention, there is provided a castor, comprising a castor body, a first bushing mounted on a top of the castor body, a bearing mounted in the first bushing, a top cover mounted on the top of the castor body to cover the first bushing and the bearing, a second bushing mounted on a bottom of the castor body, and an upright shaft in turn extending through the top cover, the bearing, the castor body and the second bushing.

The castor body has an inner portion formed with a receiving chamber to allow insertion of the second bushing. The bearing has an inner portion formed with a mounting hole mounted on the upright shaft. The top cover has an inner portion formed with a through hole mounted on the upright shaft. The second bushing has an inner portion formed with a through bore mounted on the upright shaft. The upright shaft has a lower portion formed with a shank which in turn extends through the through hole of the top cover, the mounting hole of the bearing, the receiving chamber of the castor body and the through bore of the second bushing and protrudes outward from the through bore of the second bushing. The top of the castor body has a surface formed with a mounting recess connected to the receiving chamber for mounting the first bushing. The first bushing is mounted in the mounting recess of the castor body. The first bushing has an inner portion formed with a receiving hole to receive the bearing. The bearing is mounted in and flush with the receiving hole of the first bushing. The second bushing has a substantially inverted T-shaped profile. The shank of the upright shaft has an end face formed with an outer threaded portion. The castor further comprises a washer mounted on the outer threaded portion of the upright shaft and abutting the shank of the upright shaft, and a locking nut screwed onto the outer threaded portion of the upright shaft and pressing the washer. The upright shaft has an upper portion formed with a threaded rod. The upright shaft has a mediate portion formed with an stop shoulder abutting a top of the top cover. The first bushing is located between the bearing and the castor body. The second bushing is located between the upright shaft and the castor body. The second bushing encompasses the shank of the upright shaft and the bottom of the castor body.

The primary objective of the present invention is to provide a castor having a greater structural strength to bear a heavier load.

According to the primary advantage of the present invention, the shank of the upright shaft has a greater length, and the distance between the top cover and the second bushing is increased so that the bearing and the castor body can bear a heavier load.

According to another advantage of the present invention, the distance between the top cover and the second bushing is increased so that the shank of the upright shaft and the second bushing can bear a greater rotational force to prevent the upright shaft from being loosened or vibrating during a long-term utilization so as to enhance the lifetime of the castor.

According to a further advantage of the present invention, the first bushing is located between the bearing and the castor body to provide a noise suppression function during rotation of the bearing.

According to a further advantage of the present invention, the first bushing can calibrate the size of the bearing and the castor body so that the bearing and the castor body are combined closely.

According to a further advantage of the present invention, the second bushing is located between the upright shaft and the castor body to provide a noise suppression function during rotation of the castor body. Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor for an office chair in accordance with the preferred embodiment of the present invention.

FIG. 2 is an exploded perspective view of the castor for an office chair as shown in FIG. 1.

FIG. 3 is a front cross-sectional view of the castor for an office chair as shown in FIG. 1.

FIG. 4 is a perspective view of a castor for an office chair in accordance with another preferred embodiment of the present invention.

FIG. 5 is an exploded perspective view of the castor for an office chair as shown in FIG. 4.

FIG. 6 is a front cross-sectional view of the castor for an office chair as shown in FIG. 4.

FIG. 7 is a front cross-sectional view of a conventional castor for an office chair in accordance with the prior art.

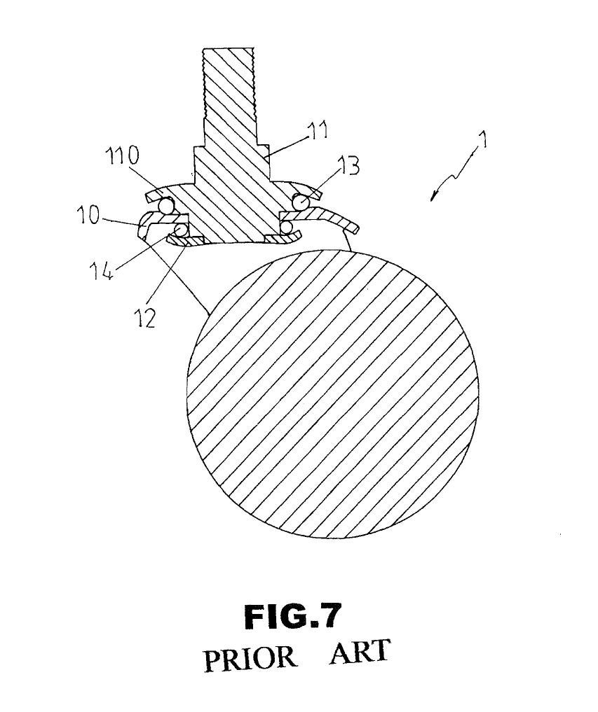

### DETAILED DESCRIPTION OF THE INVENTION

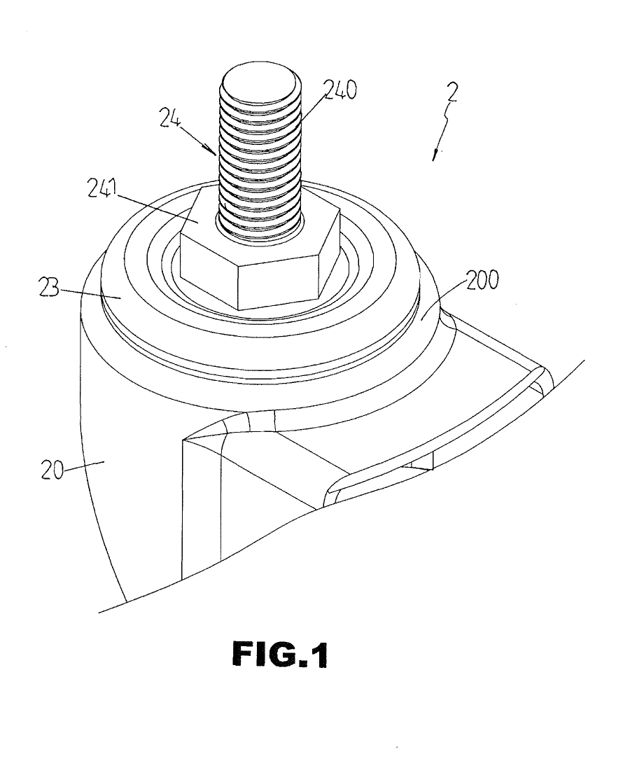

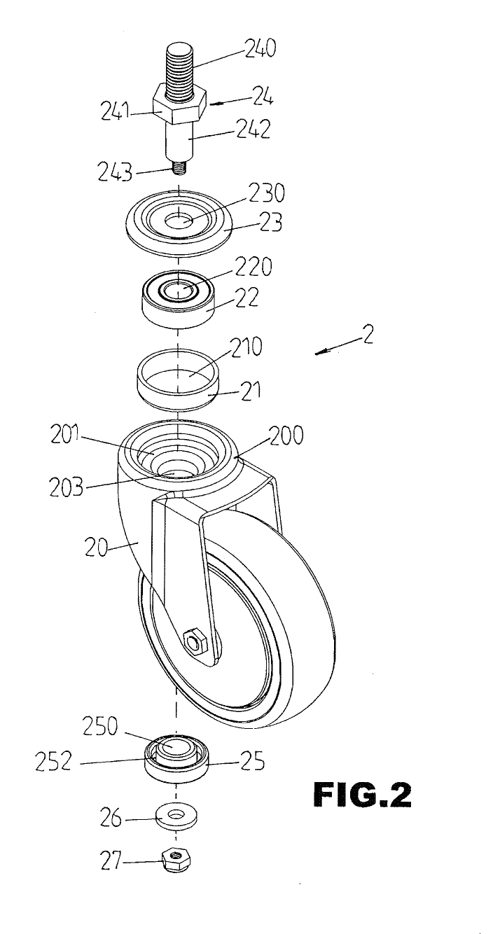

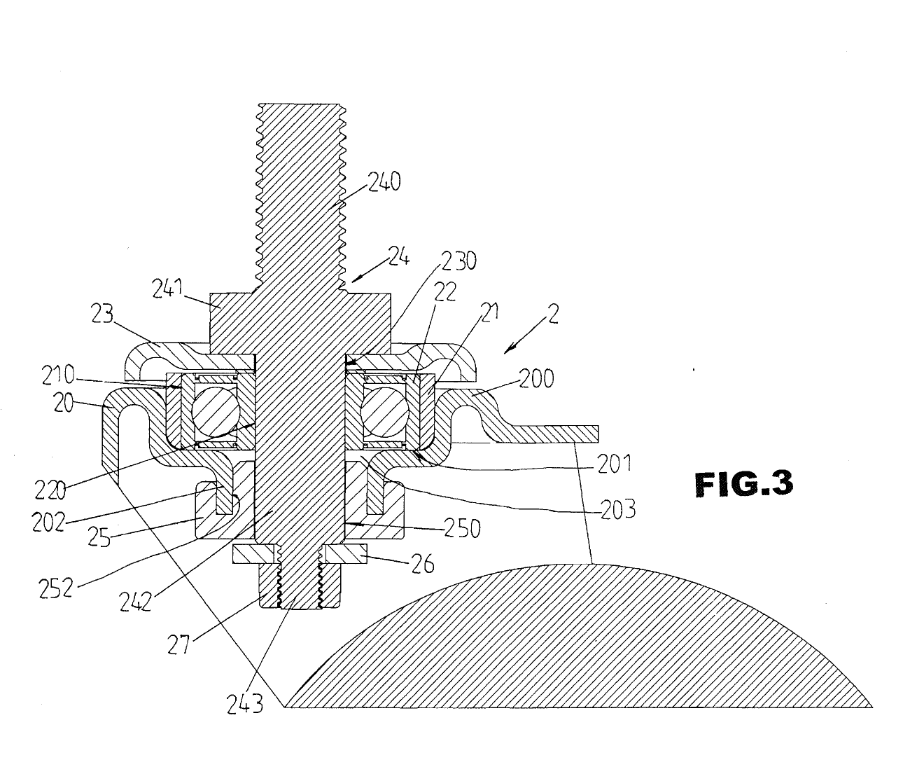

Referring to the drawings and initially to FIGS. 1-3, a castor 2 for an office chair in accordance with the preferred embodiment of the present invention comprises a castor body 20, a first bushing 21 mounted on a top 200 of the castor body 20, a bearing 22 mounted in the first bushing 21, a top cover 23 mounted on the top 200 of the castor body 20 to cover the first bushing 21 and the bearing 22, a second bushing 25 mounted on a bottom 202 of the castor body 20, and an upright shaft 24 in turn extending through the top cover 23, the bearing 22, the castor body 20 and the second bushing 25.

The castor body 20 is made of iron and has an inner portion formed with a receiving chamber 203 to allow insertion of the second bushing 25. The top 200 of the castor body 20 has a surface formed with a mounting recess 201 connected to the receiving chamber 203 for mounting the first bushing 21. The mounting recess 201 of the castor body 20 has a size greater than that of the receiving chamber 203 of the castor body 20.

The first bushing 21 is mounted in the mounting recess 201 of the castor body 20 and has an inner portion formed with a receiving hole 210 to receive the bearing 22. The first bushing 21 is located between the bearing 22 and the castor body 20 to provide a noise suppression function. In addition, the first bushing 21 can calibrate the size of the bearing 22 and the castor body 20 so that the bearing 22 and the castor body 20 are combined closely.

The bearing 22 is mounted in and flush with the receiving hole 210 of the first bushing 21. The bearing 22 is made of iron and has an inner portion formed with a mounting hole 220 mounted on the upright shaft 24. The top cover 23 is made of iron and has an inner portion formed with a through hole 230 mounted on the upright shaft 24.

The second bushing 25 has a substantially inverted T-shaped profile. The second bushing 25 is inserted into the receiving chamber 203 of the castor body 20. The second bushing 25 has an inner portion formed with a through bore 250 mounted on the upright shaft 24 and has a surface formed with a mounting groove 252 mounted on the bottom 202 of the castor body 20. The second bushing 25 is located between the upright shaft 24 and the castor body 20 to provide a noise suppression function. In addition, the second bushing 25 encompasses the shank 242 of the upright shaft 24 and the bottom 202 of the castor body 20 to enhance the strength of the upright shaft 24 and the castor body 20.

The upright shaft 24 is made of iron and has an upper portion formed with a threaded rod 240. The upright shaft 24 has a lower portion formed with a shank 242 which in turn extends through the through hole 230 of the top cover 23, the mounting hole 220 of the bearing 22, the receiving chamber 203 of the castor body 20 and the through bore 250 of the second bushing 25 and protrudes outward from the through bore 250 of the second bushing 25. The shank 242 of the upright shaft 24 has an end face formed with an outer threaded portion 243. The outer threaded portion 243 of the upright shaft 24 has a size smaller than that of the shank 242 of the upright shaft 24. The upright shaft 24 has a mediate portion formed with an stop shoulder 241 abutting a top of the top cover 23. The stop shoulder 241 of the upright shaft 24 is located between the threaded rod 240 and the shank 242 of the upright shaft 24. The stop shoulder 241 of the upright shaft 24 has a hexagonal shape and has a size greater than that of the shank 242 of the upright shaft 24.

The castor 2 further comprises a washer 26 mounted on the outer threaded portion 243 of the upright shaft 24 and abutting the shank 242 of the upright shaft 24, and a locking nut 27 screwed onto the outer threaded portion 243 of the upright shaft 24 and pressing the washer 26. The washer 26 is located between the shank 242 of the upright shaft 24 and the locking nut 27 and has a size greater than that of the through bore 250 of the second bushing 25 so that the washer 26 is movable to abut a bottom of the second bushing 25 to stop the shank 242 of the upright shaft 24.

In practice, when the castor 2 is combined with an office chair, the load of the office chair is shared by the bearing 22 and the castor body 20. At this time, the shank 242 of the upright shaft 24 has a greater length, and the distance between the top cover 23 and the second bushing 25 is increased so that the bearing 22 and the castor body 20 can bear a heavier load. In addition, the distance between the top cover 23 and the second bushing 25 is increased so that the shank 242 of the upright shaft 24 and the second bushing 25 can bear a greater rotational force.

Accordingly, the shank 242 of the upright shaft 24 has a greater length, and the distance between the top cover 23 and the second bushing 25 is increased so that the bearing 22 and the castor body 20 can bear a heavier load. In addition, the distance between the top cover 23 and the second bushing 25 is increased so that the shank 242 of the upright shaft 24 and the second bushing 25 can bear a greater rotational force to prevent the upright shaft 24 from being loosened or vibrating during a long-term utilization so as to enhance the lifetime of the castor 2. Further, the first bushing 21 is located between the bearing 22 and the castor body 20 to provide a noise suppression function during rotation of the bearing 22. Further, the first bushing 21 can calibrate the size of the bearing 22 and the castor body 20 so that the bearing 22 and the castor body 20 are combined closely. Further, the second bushing 25 is located between the upright shaft 24 and the castor body 20 to provide a noise suppression function during rotation of the castor body 20. Further, the second bushing 25 encompasses the shank 242 of the upright shaft 24 and the bottom 202 of the castor body 20 to enhance the strength of the upright shaft 24 and the castor body 20.

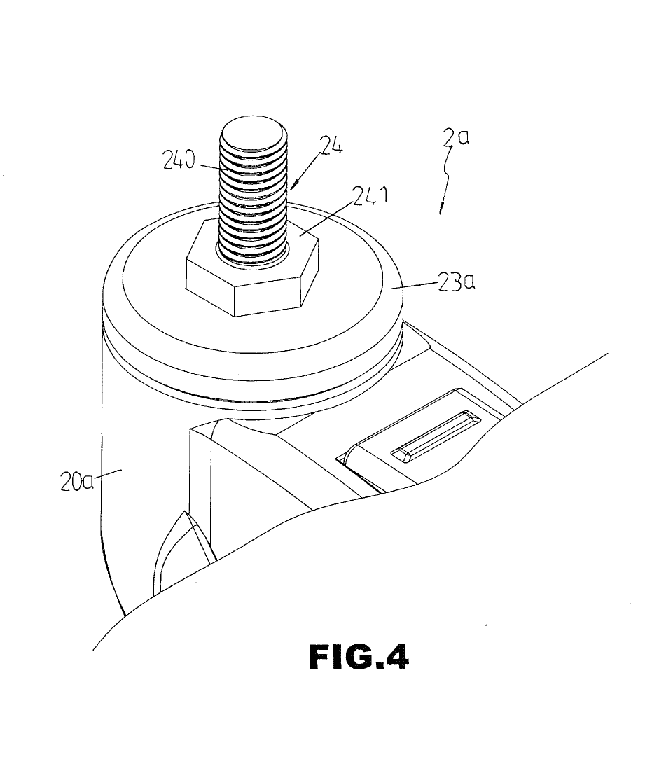

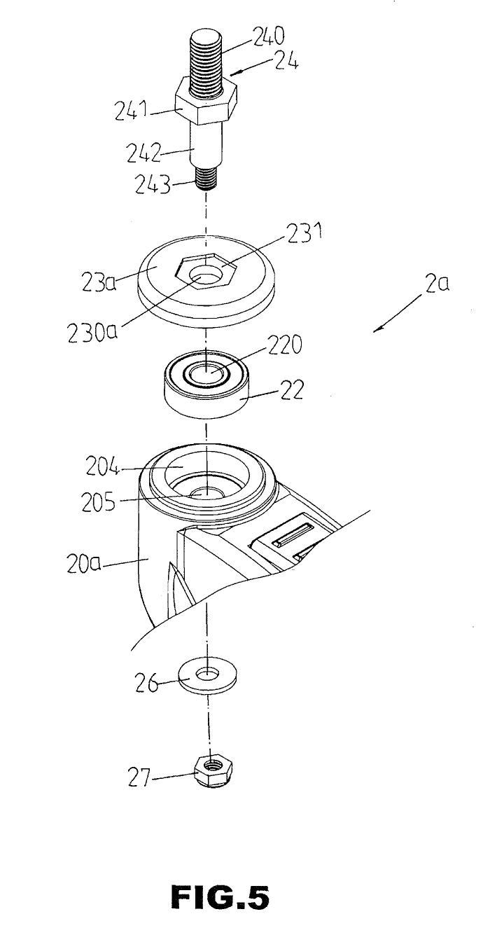

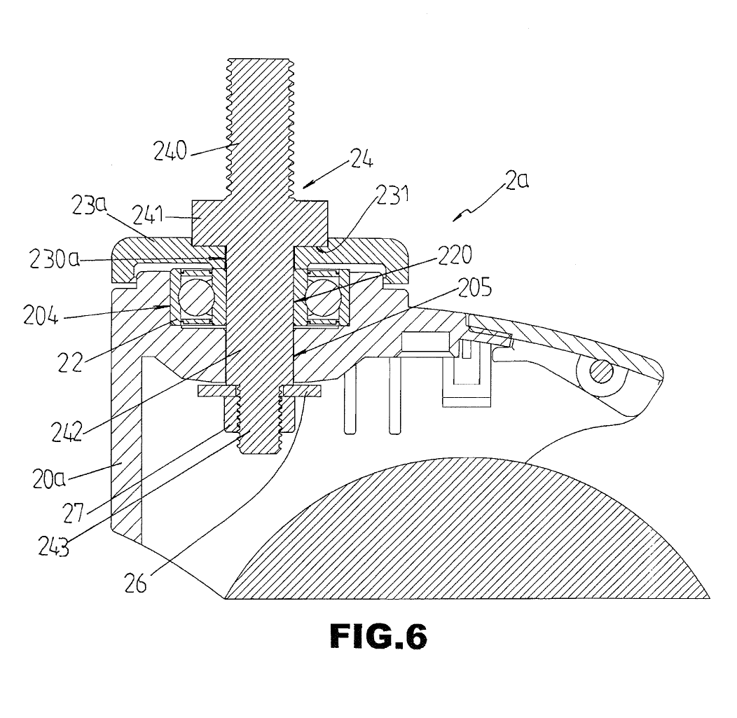

Referring to FIGS. 4-6, a castor 2a for an office chair in accordance with another preferred embodiment of the present invention is defined. In the castor 2a, the first bushing 21 and the second bushing 25 are undefined. The castor body 20a is made of plastics and has an inner portion formed with a receiving chamber 205 to allow passage of the shank 242 of the upright shaft 24. The top of the castor body 20a has a surface formed with a mounting recess 204 connected to the receiving chamber 205 for mounting the bearing 22. The top cover 23a is made of plastics and has an inner portion formed with a through hole 230a mounted on the shank 242 of the upright shaft 24. The top cover 23a has a top formed with a hexagonal fixing depression 231 to receive and fix the stop shoulder 241 of the upright shaft 24. Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor, comprising:
a castor body;
a first bushing mounted on a top of the castor body;
a bearing mounted in the first bushing;
a top cover mounted on the top of the castor body to cover the first bushing and the bearing;
a second bushing mounted on a bottom of the castor body; and
an upright shaft in turn extending through the top cover, the bearing, the castor body and the second bushing.

2. The castor of claim 1, wherein
the castor body has an inner portion formed with a receiving chamber to allow insertion of the second bushing;
the bearing has an inner portion formed with a mounting hole mounted on the upright shaft;
the top cover has an inner portion formed with a through hole mounted on the upright shaft;
the second bushing has an inner portion formed with a through bore mounted on the upright shaft;
the upright shaft has a lower portion formed with a shank which in turn extends through the through hole of the top cover, the mounting hole of the bearing, the receiving chamber of the castor body and the through bore of the second bushing and protrudes outward from the through bore of the second bushing.

3. The castor of claim 2, wherein
the top of the castor body has a surface formed with a mounting recess connected to the receiving chamber for mounting the first bushing;
the first bushing is mounted in the mounting recess of the castor body.

4. The castor of claim 3, wherein
the first bushing has an inner portion formed with a receiving hole to receive the bearing
the bearing is mounted in and flush with the receiving hole of the first bushing.

5. The castor of claim 1, wherein the second bushing has a substantially inverted T-shaped profile.

6. The castor of claim 2, wherein
the shank of the upright shaft has an end face formed with an outer threaded portion;
the castor further comprises:
a washer mounted on the outer threaded portion of the upright shaft and abutting the shank of the upright shaft; and
a locking nut screwed onto the outer threaded portion of the upright shaft and pressing the washer.

7. The castor of claim 2, wherein
the upright shaft has an upper portion formed with a threaded rod;
the upright shaft has a mediate portion formed with an stop shoulder abutting a top of the top cover.

8. The castor of claim 1, wherein the first bushing is located between the bearing and the castor body.

9. The castor of claim 1, wherein the second bushing is located between the upright shaft and the castor body.

10. The castor of claim 2, wherein the second bushing encompasses the shank of the upright shaft and the bottom of the castor body.

11. The castor of claim 2, wherein the second bushing is inserted into the receiving chamber of the castor body.

12. The castor of claim 1, wherein the second bushing has a surface formed with a mounting groove mounted on the bottom of the castor body.

13. The castor of claim 7, wherein the stop shoulder of the upright shaft is located between the threaded rod and the shank of the upright shaft.

14. The castor of claim 6, wherein the washer is located between the shank of the upright shaft and the locking nut.

15. The castor of claim 3, wherein the mounting recess of the castor body has a size greater than that of the receiving chamber of the castor body.

16. The castor of claim 6, wherein the outer threaded portion of the upright shaft has a size smaller than that of the shank of the upright shaft.

17. The castor of claim 6, wherein
the washer has a size greater than that of the through bore of the second bushing;
the washer is movable to abut a bottom of the second bushing to stop the shank of the upright shaft.

18. The castor of claim 7, wherein the stop shoulder of the upright shaft has a size greater than that of the shank of the upright shaft.
